(19) United States
(12) Patent Application Publication
(10) Pub. No.: US 2014/0370315 A1
(43) Pub. Date: Dec. 18, 2014

(54) NON-HALOGEN FLAME RETARDANT ELECTRIC WIRE CABLE

(71) Applicant: Hitachi Metals, Ltd., Tokyo (JP)

(72) Inventors: Makoto Iwasaki, Hitachi (JP); Mitsuru Hashimoto, Hitachi (JP)

(21) Appl. No.: 14/298,473

(22) Filed: Jun. 6, 2014

(30) Foreign Application Priority Data
Jun. 14, 2013 (JP) 2013-125616

(51) Int. Cl. H01B 3/44; H01B 7/295; H01B 7/282; B32B 27/08

(52) U.S. Cl. CPC H01B 3/441; H01B 3/448; B32B 27/08; H01B 7/295; H01B 7/282; B32B 2250/03; B32B 2255/10; B32B 2255/26
USPC 428/516; 428/520

(57) ABSTRACT

A non-halogen flame retardant electric wire cable includes a conductor, at least one insulating layer formed on an outer periphery of the conductor by coating the conductor with a non-halogen flame retardant resin composition, and a sheath formed on an outer periphery of the outermost insulating layer by coating the outermost insulating layer with the non-halogen flame retardant resin composition. The non-halogen flame retardant resin composition includes a base polymer including any one of ethylene-vinyl acetate copolymer having a vinyl acetate content of 25% by mass or more and polyethylene having a melting peak temperature of 115° C. to 140° C. as measured by DSC and a metal hydroxide. Ratios of the changes in the mass of the sheath and the outermost insulating layer which occur when the sheath and the outermost insulating layer are immersed in xylene heated at 110° C. for 24 hours are 420% or less.

The present application is based on Japanese patent application No. 2013-125616 filed on Jun. 14, 2013, the entire contents of which are incorporated herein by reference.

### BACKGROUND OF THE INVENTION

1. Field of the Invention

The present invention relates to a non-halogen flame retardant electric wire cable that is produced using a non-halogen flame retardant resin composition and has good oil resistance and good cable termination workability.

2. Description of the Related Art

Recently, there has been growing worldwide environmental awareness. Accordingly, there has been a demand for a non-halogen material that does not generate halogen gas when burned. In order to suppress propagation of flames in the case of a fire, that is, in order to achieve good flame retardancy, a large amount of non-halogen flame retardant such as a metal hydroxide is desirably added.

Electric wire cables used for wiring in railway vehicles, automobiles, robots, etc. desirably have good oil resistance that depends on their operating environment. A technique for achieving good oil resistance by using a polymer having high crystallinity or high polarity is known (e.g., see Japanese Unexamined Patent Application Publication No. 2010-097881).

However, when a material having good oil resistance is used for forming an outermost insulating layer and a sheath that constitute an electric wire cable, the outermost insulating layer and the sheath adhere to each other by being subjected to a high temperature during extrusion of the sheath, which makes termination of the electric wire cable difficult.

### SUMMARY OF THE INVENTION

Accordingly, an object of the present invention is to provide a non-halogen flame retardant electric wire cable that is produced using a non-halogen flame retardant resin composition and has good oil resistance and good cable termination workability.

In order to attain the above-described object, according to an aspect of the present invention, the following non-halogen flame retardant electric wire cables are provided.

[1] A non-halogen flame retardant electric wire cable including a conductor; at least one insulating layer on an outer periphery of the conductor, the at least one insulating layer being formed by coating the outer periphery of the conductor with a non-halogen flame retardant resin composition; and a sheath on an outer periphery of an outermost insulating layer that is positioned at an outermost side of the at least one insulating layer, the sheath being formed by coating the outer periphery of the outermost insulating layer with the non-halogen flame retardant resin composition. The non-halogen flame retardant resin composition constituting the outermost insulating layer and the sheath includes a base polymer including any one of ethylene-vinyl acetate copolymer (EVA) having a vinyl acetate content (VA content) of 25% by mass or more and polyethylene (PE) having a melting peak temperature of 115° C. to 140° C. as measured by differential scanning calorimetry (DSC); and 150 parts to 300 parts by mass of a metal hydroxide relative to 100 parts by mass of the base polymer. Ratios of the changes in the mass of the sheath and the outermost insulating layer which occur when the sheath and the outermost insulating layer are immersed in xylene heated at 110° C. for 24 hours are 420% or less.

[2] A non-halogen flame retardant electric wire cable based on the non-halogen flame retardant electric wire cable described in [1], in which the polyethylene (PE) is silane-grafted.

[3] A non-halogen flame retardant electric wire cable based on the non-halogen flame retardant electric wire cable described in [1] or [2], in which the base polymer further includes an acid-modified polyolefin.

[4] A non-halogen flame retardant electric wire cable based on the non-halogen flame retardant electric wire cable described in any one of [1] to [3], in which the non-halogen flame retardant resin composition is cross-linked.

According to the present invention, a non-halogen flame retardant electric wire cable that is produced using a non-halogen flame retardant resin composition and has good oil resistance and good cable termination workability may be provided.

### BRIEF DESCRIPTION OF THE DRAWINGS

FIG. 1 is a cross-sectional view of a non-halogen flame retardant electric wire cable according to a first embodiment of the present invention; and

FIG. 2 is a cross-sectional view of a non-halogen flame retardant electric wire cable according to a second embodiment of the present invention.

### DESCRIPTION OF THE PREFERRED EMBODIMENTS

### Summary of the Exemplary Embodiments

A non-halogen flame retardant electric wire cable according to an embodiment of the present invention includes a conductor; at least one insulating layer on the outer periphery of the conductor, the at least one insulating layer being formed by coating the outer periphery of the conductor with a non-halogen flame retardant resin composition; and a sheath on the outer periphery of an outermost insulating layer that is positioned at an outermost side of the at least one insulating layer, the sheath being formed by coating the outer periphery of the outermost insulating layer with the non-halogen flame retardant resin composition. The non-halogen flame retardant resin composition constituting the outermost insulating layer and the sheath includes a base polymer including any one of ethylene-vinyl acetate copolymer (EVA) having a vinyl acetate content (VA content) of 25% by mass or more and polyethylene (PE) having a melting peak temperature of 115° C. to 140° C. as measured by differential scanning calorimetry (DSC); and 150 parts to 300 parts by mass of a metal hydroxide relative to 100 parts by mass of the base polymer. Ratios of the changes in the mass of the sheath and the outermost insulating layer which occur when the sheath and the outermost insulating layer are immersed in xylene heated at 110° C. for 24 hours are 420% or less.

### Exemplary Embodiments

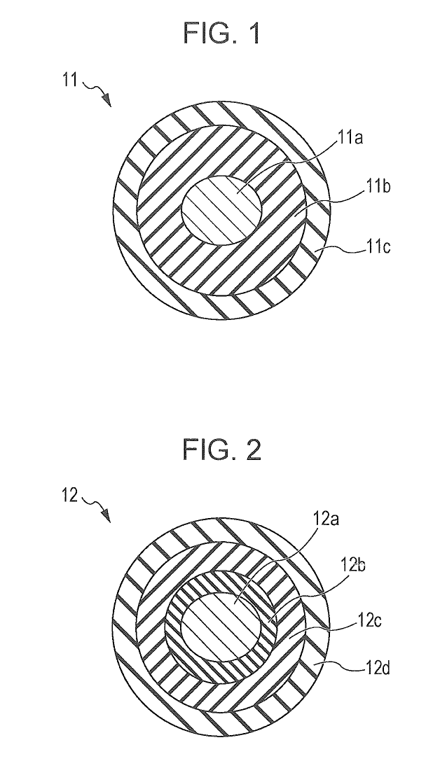

The non-halogen flame retardant electric wire cable according to the embodiment is described specifically below with reference to the attached drawings. Firstly, a non-halogen flame retardant resin composition used for producing the non-halogen flame retardant electric wire cable according to the embodiment is described. Secondly, the non-halogen flame retardant electric wire cable according to the embodiment is described more specifically with reference to FIGS. 1 and 2, which illustrate non-halogen flame retardant electric wire cables according to first and second embodiments of the present invention, respectively.

### I. Non-Halogen Flame Retardant Resin Composition

The non-halogen flame retardant resin composition used in this embodiment includes a base polymer including any one of ethylene-vinyl acetate copolymer (EVA) having a vinyl acetate content (VA content) of 25% by mass or more and polyethylene (PE) having a melting peak temperature of 115° C. to 140° C. as measured by differential scanning calorimetry (DSC); and 150 parts to 300 parts by mass of a metal hydroxide relative to 100 parts by mass of the base polymer. These components of the non-halogen flame retardant resin composition are described specifically below.

1. Base Polymer

As described above, the base polymer included in the non-halogen flame retardant resin composition used for producing the non-halogen flame retardant electric wire cable according to the embodiment includes any one of ethylene-vinyl acetate copolymer (EVA) having a vinyl acetate content (VA content) of 25% by mass or more and polyethylene (PE) having a melting peak temperature of 115° C. to 140° C. as measured by differential scanning calorimetry (DSC).

(1-1) Ethylene-Vinyl Acetate Copolymer (EVA)

The ethylene-vinyl acetate copolymer (EVA), which may be used as a constituent of the base polymer in this embodiment, desirably has a vinyl acetate content (VA content) of 25% by mass or more. If the VA content is less than 25% by mass, sufficiently good oil resistance may fail to be achieved. Although the upper limit of the VA content in the base polymer is not particularly limited, better cable termination workability may be achieved when the VA content is 25% to 70% by mass.

When EVA is used as a constituent of the base polymer, the VA content of the base polymer is derived by Expression (1) below.

In the case where the number of types of polymer constituting EVA is k=1 to n,

(VA Content in Base Polymer)=Σ XₖYₖ (1)

where X represents the VA content in polymer k (mass %), Y represents the fraction of polymer k in the entire base polymer, and k represents a natural number of 1 to n.

(1-2) Polyethylene (PE)

The polyethylene (PE), which may be used as a constituent of the base polymer in this embodiment and as an alternative to the ethylene-vinyl acetate copolymer (EVA) described above, desirably has a melting peak temperature of 115° C. to 140° C. as measured by differential scanning calorimetry (DSC). If the melting peak temperature is less than 115° C., sufficiently good oil resistance may fail to be achieved. If the melting peak temperature exceeds 140° C., a reduction in breaking elongation may occur when a large amount of metal hydroxide is added.

Examples of PE that can be used as a constituent of the base polymer include ultralow-density polyethylene, low-density polyethylene, and high-density polyethylene.

These polyethylenes may be silane-grafted. Silane grafting increases the adhesion of polyethylene to a metal hydroxide, which enhances the mechanical strength of the electric wire cable. Addition of a silanol condensation catalyst to polyethylene allows silane cross-linking to be performed after extrusion molding, which eliminates the need for performing a cross-linking step. When silane cross-linking is performed, a silane compound is added. The silane compound needs to include a group capable of reacting with a polymer and an alkoxy group that forms a cross-link due to silanol condensation. Examples of the silane compound include vinylsilane compounds such as vinyltrimethoxysilane, vinyltriethoxysilane, and vinyl-tris(β-methoxyethoxy)silane; aminosilane compounds such as γ-aminopropyltrimethoxysilane, γ-aminopropyltriethoxysilane, N-β-(aminoethyl)-γ-aminopropyltrimethoxysilane, β-(aminoethyl)-γ-aminopropylmethyldimethoxysilane, and N-phenyl-γ-aminopropyltrimethoxysilane; epoxysilane compounds such as β-(3,4-epoxycyclohexyl)ethyltrimethoxysilane, γ-glycidoxypropyltrimethoxysilane, and γ-glycidoxypropylmethyldiethoxysilane; acrylic silane compounds such as γ-methacryloxypropyltrimethoxysilane; polysulfide silane compounds such as bis(3-[triethoxysilyl]propyl)disulfide and bis(3-[triethoxysilyl]propyl)tetrasulfide; and mercaptosilane compounds such as 3-mercaptopropyltrimethoxysilane and 3-mercaptopropyltriethoxysilane.

Examples of the silanol condensation catalyst include dibutyltin dilaurate, dibutyltin diacetate, dibutyltin dioctoate, tin(II) acetate, tin(II) caprylate, zinc caprylate, lead naphthenate, and cobalt naphthenate.

(1-3) Other Constituents of Base Polymer

Optionally, in addition to ethylene-vinyl acetate copolymer (EVA) or polyethylene (PE) which constitutes the base polymer used in this embodiment, an acid-modified polyolefin may be added to the base polymer. For example, in either case where EVA or PE is used as a constituent of the base polymer, an acid-modified polyolefin may be added to the base polymer in order to enhance the mechanical strength of the electric wire cable. This increases the adhesion of the base polymer to a metal hydroxide and thereby enhances the mechanical strength of the electric wire cable. Examples of an acid that can be used for modification of polyolefin include maleic acid, maleic anhydride, and fumaric acid.

2. Metal Hydroxide

Examples of the metal hydroxide (non-halogen flame retardant) included in the non-halogen flame retardant resin composition used for producing the non-halogen flame retardant electric wire cable according to the embodiment include magnesium hydroxide, aluminium hydroxide, calcium hydroxide, and these metal hydroxides containing nickel as a solid solution. Aluminium hydroxide and magnesium hydroxide are exemplarily used because they have good flame retardancy. Specifically, the amounts of heat absorbed during the decomposition of aluminium hydroxide and magnesium hydroxide are 1,500 J/g to 1,600 J/g, which are larger than the amount of heat absorbed during the decomposition of calcium hydroxide, which is about 1,000 J/g. These metal hydroxides may be used alone or in a mixture of two or more.

Optionally, these metal hydroxides may be surface-treated with a silane coupling agent; a titanate-based coupling agent; or fatty acid or a metal salt of a fatty acid, such as stearic acid or calcium stearate with consideration of the dispersibility of the metal hydroxides. Optionally, an adequate amount of metal hydroxide other than those described above may be added to the non-halogen flame retardant resin composition.

The amount of metal hydroxide added is desirably 150 parts to 300 parts by mass and is preferably 180 parts to 250 parts by mass relative to 100 parts by mass of the base polymer. If the amount of metal hydroxide added is less than 150 parts by mass, sufficiently good flame retardancy may fail to be achieved. If the amount of metal hydroxide exceeds 300 parts by mass, the mechanical properties (e.g., breaking elongation) of the electric wire cable may be degraded.

3. Other Components

In addition to the base polymer and the metal hydroxide, as needed, the non-halogen flame retardant resin composition used for producing the non-halogen flame retardant electric wire cable according to the embodiment may include other components such as a cross-linking agent, a cross-linking aid, a flame retardant aid, an ultraviolet absorber, a light stabilizer, a softener, a lubricant, a colorant, a reinforcing agent, a surfactant, an inorganic filler, a plasticizer, a metal chelating agent, a blowing agent, a compatibilizer, a processing aid, and a stabilizer.

4. Cross-Linking

The non-halogen flame retardant resin composition used for producing the non-halogen flame retardant electric wire cable according to the embodiment is exemplary cross-linked in order to enhance the mechanical properties of the non-halogen flame retardant electric wire cable. Examples of a cross-linking method include electron beam cross-linking in which, after being molded, a non-halogen flame retardant resin composition is irradiated with an electron beam to cause cross-linking; chemical cross-linking in which a cross-linking agent (e.g., an organic peroxide or a sulfur compound) is added to a non-halogen flame retardant resin composition and, after being molded, the resin composition is heated to cause cross-linking; and silane cross-linking.

5. Mass Change Ratio in Hot Xylene

When the non-halogen flame retardant resin composition used for producing the non-halogen flame retardant electric wire cable according to the embodiment is formed into an insulating layer and a sheath that constitute the electric wire cable as described below, ratios of the changes in the mass of the sheath and the insulating layer (outermost insulating layer, in the case where the non-halogen flame retardant electric wire cable includes a plurality of insulating layers) which occur when the sheath and the insulating layer are immersed in xylene heated at 110° C. for 24 hours are 420% or less. If the mass change ratios exceed 420%, adhesion between the insulating layer (outermost insulating layer) and the sheath may occur, which leads to degradation of cable termination workability and oil resistance. This is because an excessively high mass change ratio means that the cross-linking density is not sufficiently high and therefore, when the sheath and the insulating layer (outermost insulating layer) are included of the same material, a portion of the insulating layer (outermost insulating layer) may be molten during formation of the sheath, which increases the adhesion between the sheath and the insulating layer (outermost insulating layer). In addition, when the electric wire cable is immersed in an oil heated to a high temperature, the oil is diffused in the insulating layer (outermost insulating layer), which may reduce the mechanical strength of the electric wire cable.

### II. Non-Halogen Flame Retardant Electric Wire Cable

As shown in FIG. 1, the non-halogen flame retardant electric wire cable according to the first embodiment of the present invention is a non-halogen flame retardant electric wire cable 11 including a conductor 11a, a single insulating layer 11b formed by coating the outer periphery of the conductor 11a with a non-halogen flame retardant resin composition, and a sheath 11c formed by coating the outer periphery of the insulating layer 11b with a non-halogen flame retardant resin composition. The insulating layer 11b and the sheath 11c are included of the same non-halogen flame retardant resin composition described above.

As shown in FIG. 2, the non-halogen flame retardant electric wire cable according to the second embodiment of the present invention is a non-halogen flame retardant electric wire cable 12 including a conductor 12a, a plurality of insulating layers, namely, an inner insulating layer 12b and an outer insulating layer 12c, formed by coating the outer periphery of the conductor 12a with a non-halogen flame retardant resin composition and the like, and a sheath 12d formed by coating the outer periphery of the outer insulating layer (outermost insulating layer) 12c, which is positioned at the outermost aide of the insulating layers 12b and 12c, with a non-halogen flame retardant resin composition. The outermost insulating layer 12c and the sheath 12d are composed of the same non-halogen flame retardant resin composition described above.

Ratios of the changes in the mass of the sheath and the insulating layer (outermost insulating layer, in the case where the non-halogen flame retardant electric wire cable includes a plurality of insulating layers) used in the embodiment which occur when the sheath and the insulating layer are immersed in xylene heated at 110° C. for 24 hours are 420% or less. If the mass change ratios exceed 420%, adhesion between the insulating layer (outermost insulating layer) and the sheath may occur, which leads to degradation of cable termination workability and oil resistance. In addition, when the electric wire cable is immersed in an oil heated to a high temperature, the oil is diffused in the insulating layer (outermost insulating layer), which may reduce the mechanical strength of the electric wire cable.

As needed, a separator, braiding, etc. may be applied to the electric wire cable.

When a plurality of insulating layers are formed, insulating layers other than the outermost layer may be formed by, for example, extrusion-coating with a polyolefin resin. Examples of the polyolefin resin include low-density polyethylene, EVA, ethylene-ethyl acrylate copolymer, ethylene-methyl acrylate ethylene-glycidyl methacrylate copolymer, and maleic anhydride polyolefin. These polyolefin resins may be used alone or in a mixture of two or more. A rubber material may also be used and examples thereof include an ethylene-propylene copolymer rubber (EPR), an ethylene-propylene-diene terpolymer rubber (EPDM), an acrylonitrile-butadiene rubber (NBR), a hydrogenated NBR (HNBR), an acrylic rubber, an ethylene-acrylate copolymer rubber, an ethylene-octene copolymer rubber (EOR), an ethylene-vinyl acetate copolymer rubber, an ethylene-butene-1 copolymer rubber (EBR), a butadiene-styrene copolymer rubber (SBR), an isobutylene-isoprene copolymer rubber (IIR), a block copolymer rubber including a polystyrene block, a urethane rubber, and a phosphazene rubber. These rubber materials may be used alone or in a mixture of two or more. The material of the insulating layers other than the outermost layer is not limited to the above-described polyolefin resins and the above-described rubber materials, and any materials having insulating properties may be used.

### EXAMPLES

The non-halogen flame retardant electric wire cable according to an embodiment of the present invention is more specifically described with reference to Examples described below. In Examples 1 to 3, ethylene-vinyl acetate copolymer (EVA) was used as a constituent of a base polymer included in a non-halogen flame retardant resin composition. In Examples 4 and 5, polyethylene (PE) was used as a constituent of the base polymer. In Example 6, silane-grafted polyethylene (PE) was used as a constituent of the base polymer. Note that, the present invention is not limited by Examples described below.

### Example 1

The following amounts of components of a non-halogen flame retardant resin composition were prepared (see Table 1). The vinyl acetate content (VA content) of the prepared base polymer was calculated to be 25.2% by mass by Expression (1) shown above.

Ethylene-vinyl acetate copolymer (EVA) as a base polymer (“EV550” produced by DUPONT-MITSUI POLYCHEMICALS CO., LTD., VA content: 14%) 65 parts by mass

Ethylene-vinyl acetate copolymer (EVA) as a base polymer (“45X” produced by DUPONT-MITSUI POLYCHEMICALS CO., LTD., VA content: 46%) 35 parts by mass

Organic peroxide as an optional component (“PERBUTYL P” produced by NOF CORPORATION) 2 parts by mass

Magnesium hydroxide as a metal hydroxide (“KISUMA 5L” produced by Kyowa Chemical Industry Co., Ltd.) 150 parts by mass

The above amounts of components were mixed and kneaded with a 14-inch roller to prepare a non-halogen flame retardant resin composition.

Then, a non-halogen flame retardant electric wire cable shown in FIG. 2 was prepared in the following manner.

A resin composition prepared by adding 2 parts by mass of an organic peroxide (“PERBUTYL P” produced by NOF CORPORATION) to 100 parts by mass of ethylene-butene-1 copolymer rubber (“TAFMER A-4050S” produced by Mitsui Chemicals, Inc.) was extruded with a 4.5-inch continuously steam-cross-linking extruder onto a tin-plated conductor composed of 80 strands of 0.40-mm-diameter wire so as to form an inner insulating layer having a thickness of 0.5 mm covering the tin-plated conductor. The resin composition was cross-linked for 3 minutes using high-pressure steam at 1.8 MPa. Subsequently, a non-halogen flame retardant resin composition having the composition shown in Table 1 was kneaded with a 14-inch roller and extruded with a 4.5-inch continuously steam-cross-linking extruder onto the outer periphery of the inner insulating layer so as to form an outer insulating layer having a thickness of 1.7 mm covering the inner insulating layer. The resin composition was cross-linked for 3 minutes using high-pressure steam at 1.8 MPa. Then, a non-halogen flame retardant resin composition having the same composition as the outer insulating layer was extruded with a 4.5-inch continuously steam-cross-linking extruder onto the outer surface of the outer insulating layer so as to form a sheath having a thickness of 1.0 mm covering the outer insulating layer. The resin composition was cross-linked for 3 minutes using high-pressure steam at 1.8 MPa.

Table 1 shows the composition of the non-halogen flame retardant resin composition prepared in Example 1 and the results of the evaluations of the non-halogen flame retardant electric wire cable, which are described below.

### Examples 2 and 3

A non-halogen flame retardant resin composition was prepared as in Example 1 except that the composition of the non-halogen flame retardant resin composition was changed to that shown in Table 1. Specifically, the type of or the amount of metal hydroxide included in the base polymer were changed. Table 1 shows the results of the evaluations of the non-halogen flame retardant electric wire cable.

### Examples 4 and 5

A non-halogen flame retardant resin composition was prepared as Example 1 except that the following changes were made: the composition of the non-halogen flame retardant resin composition was changed to that shown in Table 1 (specifically, polyethylene (PE) was used as a constituent of a base polymer and the amount of metal hydroxide used was changed); the resulting resin composition was extruded with a 40-mm extruder onto the outer periphery of the inner insulating layer so as to form an outer insulating layer having a thickness of 1.7 mm covering the inner insulating layer, and the resin composition was cross-linked with an electron beam dose of 10 Mrad; and a non-halogen flame retardant resin composition having the same composition as the outer insulating layer was extruded with a 40-mm extruder onto the outer periphery of the outer insulating layer so as to form a sheath having a thickness of 1.0 mm covering the outer insulating layer, and the resin composition was cross-linked with an electron beam dose of 10 Mrad.

### Example 6

A non-halogen flame retardant resin composition was prepared as in Example 1 except that the following changes were made: the composition of the non-halogen flame retardant resin composition was changed to that shown in Table 1 (specifically, silane-grafted polyethylene (PE) was used as a base polymer and 7 parts by mass of a catalyst (“CT/7-LR_UV” produced by Solvay) was dry-blended to the resin composition); the resulting resin composition was extruded with a 40-mm extruder onto the outer periphery of the inner insulating layer so as to form an outer insulating layer having a thickness of 1.7 mm covering the inner insulating layer, and the resin composition was cross-linked with an electron beam dose of 10 Mrad; and a non-halogen flame retardant resin composition having the same composition as the outer insulating layer was extruded with a 40-mm extruder onto the outer periphery of the outer insulating layer so as to form a sheath having a thickness of 1.0 mm covering the outer insulating layer, and the resin composition was cross-linked with an electron beam dose of 10 Mrad.

### Comparative Example 1

A non-halogen flame retardant resin composition was prepared as in Example 1 except that the composition of the non-halogen flame retardant resin composition was changed to that shown in Table 2. Specifically, the vinyl acetate content (VA content) of the ethylene-vinyl acetate copolymer (EVA) used as a base polymer was 23.6% by mass, that is, less than 25% by mass. Table 2 shows the results of the evaluations of the non-halogen flame retardant electric wire cable.

### Comparative Example 2

A non-halogen flame retardant resin composition was prepared as in Example 1 except that the composition of the non-halogen flame retardant resin composition was changed to that shown in Table 2. Specifically, the specific ethylene-vinyl acetate copolymer (EVA) and the specific polyethylene (PE) were not used as a base polymer and the amount of metal oxide added was changed. Table 2 shows the results of the evaluations of the non-halogen flame retardant electric wire cable.

### Comparative Example 3

A non-halogen flame retardant resin composition was prepared as in Example 1 except that the composition of the non-halogen flame retardant resin composition was changed to that shown in Table 2. Specifically, the specific ethylene-vinyl acetate copolymer (EVA) and the specific polyethylene (PE) were not used as a base polymer and the amount of metal oxide added was changed. Table 2 shows the results of the evaluations of the non-halogen flame retardant electric wire cable.

### Method for Evaluating Non-Halogen Flame Retardant Electric Wire Cable

The following properties of the non-halogen flame retardant electric wire cable were evaluated by the following evaluation tests.

(1) Flame Retardancy

The flame retardancy of the electric wire cable was evaluated by a vertical flame test conforming to EN60332-1-2. A 550-mm electric wire cable was vertically held, and the electric wire cable was brought into contact with a flame for 60 seconds at a position 475 mm from the upper end of the electric wire cable. Then, the flame was moved away from the electric wire cable. The flame retardancy of the electric wire cable was evaluated as “Passed” when the afterflame was automatically extinguished within the range of 50 mm to 540 mm from the upper end of the electric wire cable and evaluated as “Failed” when the afterflame spread beyond the range.

(2) Breaking Elongation

The breaking elongation of the electric wire cable was evaluated by conducting a tensile test conforming to EN60811-1-1 at a testing speed of 200 mm/min using a dumbbell test piece No. 6, which was prepared by cutting the outer insulating layer (outermost insulating layer). The breaking elongation of the electric wire cable was evaluated as “Passed” when the breaking elongation was 125% or more and evaluated as “Failed” when the breaking elongation was less than 125%.

(3) Oil Resistance

The oil resistance of the electric wire cable was evaluated by immersing a dumbbell test piece No. 6, which was prepared by cutting the outer insulating layer (outermost insulating layer), for 72 hours in a test oil IRM902 heated at 100° C. and subsequently conducting a tensile test conforming to EN60811-2-1 using the dumbbell test piece No. 6. The oil resistance of the electric wire cable was evaluated as “Passed” when the retention of tensile strength was within the range of 130% to 70% and evaluated as “Failed” when the retention of tensile strength was outside the range.

(4) Mass Change Ratio in Hot Xylene

The mass change ratio in hot xylene was evaluated by immersing a test sample, which was prepared by cutting the outer insulating layer into a piece having a mass of 0.5 g, for 24 hours in xylene heated at 110° C., then immediately measuring the mass of the test sample, and calculating the ratio of change in the mass of the test sample. The mass change ratio in hot xylene of the electric wire cable was evaluated as “Passed” when the mass change ratio was 420% or less and evaluated as “Failed” when the mass change ratio exceeded 420%.

(5) Cable Termination Workability

The cable termination workability of the electric wire cable was evaluated in the following manner. The sheath of the electric wire cable was cut off with a knife. The cable termination workability of the electric wire cable was evaluated as “Passed” when the sheath was peeled from the outer insulating layer at the interface therebetween without causing the whitening of the outer insulating layer and evaluated as “Failed” when the whitening of the outer insulating layer or fracturing of the material of the outer insulating layer or the sheath occurred.

(6) Overall Evaluation

As an overall evaluation, an electric wire cable that was evaluated as “Passed” in all evaluations was evaluated as “Passed” and an electric wire cable that was evaluated as “Failed” even in one evaluation was evaluated as “Failed”.

As shown in Table 1, the electric wire cables prepared in Examples 1 to 6 were evaluated as “Passed” in all evaluations in terms of flame retardancy, breaking elongation, oil resistance, mass change ratio in hot xylene, and cable termination workability and therefore evaluated as “Passed” as an overall evaluation.

In contrast, as shown in Table 2, the electric wire cable prepared in Comparative Example 1 was evaluated as “Failed” in terms of oil resistance and therefore evaluated as “Failed” as an overall evaluation. The electric wire cables prepared in Comparative Examples 2 and 3 were evaluated as “Failed” in terms of oil resistance, mass change ratio in a hot xylene, and cable termination workability and therefore evaluated as “Failed” as an overall evaluation.

TABLE 1

| | Examples | | | | | |
|---|---|---|---|---|---|---|
| Items | 1 | 2 | 3 | 4 | 5 | 6 |
| EVA (VA content: 14 mass %)¹⁾ | 65 | 65 | 65 | | | |
| EVA (VA content: 46 mass %)²⁾ | 35 | 35 | 35 | | | |
| PE (melting point: 118° C.)³⁾ | | | | 100 | 100 | |
| Silane-grafted PE⁴⁾ | | | | | | 93 |
| Catalyst⁵⁾ | | | | | | 7 |
| Organic peroxide⁶⁾ | 2 | 2 | 2 | | | |
| Magnesium hydroxide⁷⁾ | 150 | 300 | | 150 | 300 | |
| Aluminium hydroxide⁸⁾ | | | 150 | | | |
| Base polymer VA content (mass %) | 25.2 | 25.2 | 25.2 | 0 | 0 | 0 |
| Flame retardancy | Passed | Passed | Passed | Passed | Passed | Passed |
| Breaking Elongation (%) | 300 | 160 | 310 | 170 | 130 | 180 |
| Evaluation | Passed | Passed | Passed | Passed | Passed | Passed |
| Oil resistance (%) | 85 | 90 | 88 | 80 | 85 | 70 |
| Evaluation | Passed | Passed | Passed | Passed | Passed | Passed |
| Mass change ratio (%) | 190 | 160 | 195 | 230 | 220 | 420 |
| Evaluation | Passed | Passed | Passed | Passed | Passed | Passed |
| Cable termination workability | Passed | Passed | Passed | Passed | Passed | Passed |
| Overall evaluation | Passed | Passed | Passed | Passed | Passed | Passed |

¹⁾“EV550” produced by DUPONT-MITSUI POLYCHEMICALS CO., LTD.
²⁾“45X” produced by DUPONT-MITSUI POLYCHEMICALS CO., LTD.
³⁾“SP1510” produced by Prime Polymer Co., Ltd.
⁴⁾“GFR365” produced by Solvey
⁵⁾“CT/7-LR_UV” produced by Solvey
⁶⁾“PERBUTYL P” produced by NOF CORPORATION
⁷⁾“KISUMA 5L” produced by Kyowa Chemical Industry Co., Ltd.
⁸⁾“BF013STV” produced by Nippon Light Metal Company, Ltd.

TABLE 2

| | Comparative examples | | |
|---|---|---|---|
| Items | 1 | 2 | 3 |
| EVA (VA content: 14 mass %) | 70 | | |
| EVA (VA content: 46 mass %) | 30 | | |
| Ethylene-butene-1 copolymer | | 100 | |
| (melting point: 66° C. ⁹⁾ | | | |
| Metallocene LLDPE | | | 100 |
| (melting point: 111° C.) ¹⁰⁾ | | | |
| Organic peroxide | 2 | | |
| Magnesium hydroxide | 150 | 300 | 300 |
| Aluminium hydroxide | | | |
| Base polymer VA content (mass %) | 23.6 | 0 | 0 |
| Flame retardancy | Passed | Passed | Passed |
| Breaking Elongation (%) | 290 | 200 | 180 |
| Evaluation | Passed | Passed | Passed |
| Oil resistance (%) | 68 | 40 | 50 |
| Evaluation | Failed | Failed | Failed |
| Mass change ratio (%) | 240 | 430 | 425 |
| Evaluation | Passed | Failed | Failed |
| Cable termination workability | Passed | Failed | Failed |
| Overall evaluation | Failed | Failed | Failed |

⁹⁾ “TAFMER A-4050S” produced by Mitsui Chemicals, Inc.
¹⁰⁾ “Evolue (Registered trademark) SP1020” produced by Prime Polymer Co., Ltd.

What is claimed is:

1. A non-halogen flame retardant electric wire cable comprising:
a conductor;
at least one insulating layer on an outer periphery of the conductor, the at least one insulating layer being formed by coating the outer periphery of the conductor with a non-halogen flame retardant resin composition; and
a sheath on an outer periphery of an outermost insulating layer that is positioned at an outermost side of the at least one insulating layer, the sheath being formed by coating the outer periphery of the outermost insulating layer with the non-halogen flame retardant resin composition,
wherein the non-halogen flame retardant resin composition constituting the outermost insulating layer and the sheath includes,
a base polymer including any one of ethylene-vinyl acetate copolymer (EVA) having a vinyl acetate content (VA content) of 25% by mass or more and polyethylene (PE) having a melting peak temperature of 115° C. to 140° C. as measured by differential scanning calorimetry (DSC); and
150 parts to 300 parts by mass of a metal hydroxide relative to 100 parts by mass of the base polymer, and
wherein ratios of the changes in the mass of the sheath and the outermost insulating layer which occur when the sheath and the outermost insulating layer are immersed in xylene heated at 110° C. for 24 hours are 420% or less.

2. The non-halogen flame retardant electric wire cable according to claim 1,
wherein the polyethylene (PE) comprises silane-grafted.

3. The non-halogen flame retardant electric wire cable according to claim 1,
wherein the base polymer further includes an acid-modified polyolefin.

4. The non-halogen flame retardant electric wire cable according to claim 1,
wherein the non-halogen flame retardant resin composition comprises cross-linked.
